(19) United States
(12) Patent Application Publication
(10) Pub. No.: US 2004/0037283 A1
(43) Pub. Date: Feb. 26, 2004

(54) High speed data transmission method and transmission system therefor

(76) Inventors: Marc Porato, Loconville (FR); Francois Rieul, Saint Germain En Laye (FR)

Correspondence Address: QUARLES & BRADY LLP, 411 E. WISCONSIN AVENUE, SUITE 2040, MILWAUKEE, WI, 53202-4497, US

(21) Appl. No.: 10/332,886

(22) PCT Filed: Jul. 12, 2001
(86) PCT No.: PCT/FR01/02264

(30) Foreign Application Priority Data
Jul. 12, 2000 (FR) 00/09086

(51) Int. Cl. H04L 12/28

(52) U.S. Cl. 370/392

(57) ABSTRACT

According to the method of high bit rate data transmission between a sender appliance (9) and receiver appliances (1, 2, 3, 4) of a digital radiotelephony network, the data are transmitted to these receiver appliances through a group of common broadcasting paths when the former present a data reception request.

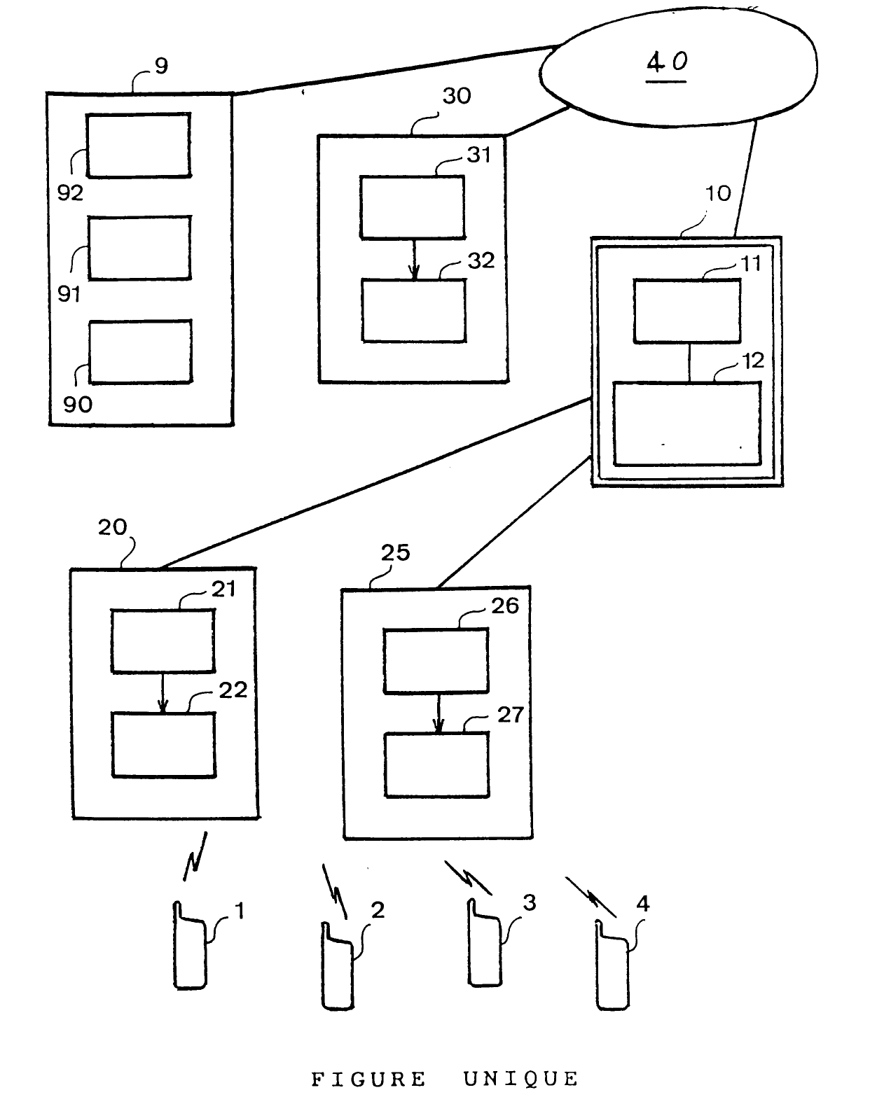

The present invention relates to the high bit rate transmission of data, of the video data type, in a radiotelephony network.

Cellular telephone networks offer their users bit rates which can be tailored according to their requirements. It is thus possible to transmit digital moving pictures through several elementary telephone paths, of conventional bit rate, grouped together to form a high bit rate channel. It is thus possible to organize for example video conferences, to receive films and other audiovisual programmes originating from a server, or other non “real time” data, the volume of which is, however, such that they need to be transmitted at high bit rate if one wishes to be able to utilize them without loss of time.

However, telephone networks are engineered for voice traffic, or data traffic with a bit rate of like magnitude, so that the traffic overload rapidly becomes excessive when the number of high bit rate communications is no longer negligible and when they then monopolize the transmission resources.

The present invention is aimed at better adaptation of radio telephone networks to the requirements of high bit rate transmissions.

To this end, the invention relates first of all to a method of high bit rate data transmission between a sender appliance and receiver appliances of a digital radiotelephony network, method characterized in that, at the request of receiver appliances of a plurality of these appliances, the data are transmitted to these receiver appliances through a group of common broadcasting paths.

The invention also relates to a system for high bit rate data transmission comprising a digital radiotelephony network, with data transmission paths and a manager for allocating the paths, system characterized in that the manager comprises means for updating a table of transmission requests from various receiver appliances and for, at their request, allocating them one and the same group of common data broadcasting paths.

The invention will be better understood with the aid of the following description of a preferred mode of implementation of the method of the invention, with reference to the single figure which diagrammatically represents a high bit rate data transmission system implementing the method of the invention.

The high bit rate data transmission system represented comprises a plurality of data receiver appliances, here four appliances referenced 1, 2, 3, 4, linked, through a telephone network 10, 20, 25, 30, 40, to a data sender appliance 9.

More precisely here, we are concerned with a digital cellular radiotelephony network, here the GSM/GPRS network, comprising a plurality of base stations, of which the two stations, 20, 25 represented are managed by a manager or local server 10 for allocating the temporal paths of the GSM network. The local server 10 is also in this example a traffic switch and serves as traffic concentrator for linking the stations 20, 25 to a wire-based transport network 40, here to the X 25 packet transport standard, which forms a high bit rate skeleton for interlinking various switches, such as that referenced 10, to which various base stations are linked, such as those referenced 20 and 25. The sender appliance 9, here linked directly to the transport network 40, sends thereto, in this example, streams of moving pictures in the form of high bit rate digital data, here representing various television programmes defined by identifiers in a table 91 managed by a processor 90 of the sender appliance 9. The expression “high bit rate” is understood here to mean a bit rate greater than that offered by a temporal path of a transmit/receive frame managed by each base station 20, 25, for linking the mobile terminals or appliances 1 to 4 of its radio cell to the GSM network.

As a variant, some of the appliances 1 to 4 are wire-link appliances, linked to a cell of the GSM network through the Internet network.

The appliances 1 to 4, wire-based or as here radio, fixed or mobile, may in particular be relatively powerful fixed appliances, such as digital television receivers or computers. Their representation in the form of handsets therefore merely corresponds to a particular case.

Each base station 20, 25, comprises a respective memory 21, 26, or connection circuits control table 22, 27, catering for the radio sending and receiving of the data in the frame of the relevant cell, and their dispatch in the GSM network as a function of the identity of the appliance 1 to 4 to which each temporal path has been assigned in the table 21, 26.

The local server 10 comprises a processor 11 for receiving and processing requests for receiving programmes, sent by the various appliances 1 to 4. The processor 11 manages a memory or table 12 containing the list of identifiers of the programmes of the table 91. The table 12 furthermore comprises, for each programme, the list of stations 20, 25 at which each relevant programme transmitted by the appliance 9 arrives. The telephone number of those of the appliances 1 to 4 which are active receivers of the relevant programme is even, in this example, stored in association with a number identifying the station 20, 25 of the cell of each active receiver appliance.

To the transport network 40 is furthermore linked a central manager server 30 of rights of the appliances 1 to 4, which comprises a processor 31 and a memory or table 32 containing a list specifying the rights of the appliances 1 to 4 as regards the use of the various digital data streams supplied by the sender 9. The table 32 furthermore here contains the sum total of the contents of the various tables 12 of the various local servers such as that referenced 10.

The manner of operation of the high bit rate data transmission system represented will now be explained in greater detail.

In a general manner, at the request of any receiver appliance 1 to 4, the GSM network 10, 20, 25, 30, 40 transmits to the latter the data of a programme, originating from the sender appliance 9, through a group of common broadcasting paths.

The size of the group, or number of temporal paths associated in parallel, is determined by the ratio of the digital bit rate of the programme to the transmission capacity of a GSM path.

Since, here, each receiver appliance 1 to 4 is a radio receiver, it in fact receives, at the level of its antenna, the entirety of the data of the temporal paths of the frame of its cell but stores and processes only the data which relate to it, in the temporal paths which have been assigned to it on its own request.

To this end, a receiver appliance such as that referenced 1, initially quiescent, sends a programme request to its station, here the station 20, to request a connection with the sender appliance 9. This request is here sent in a service or signalling channel of the frame and, for example in the form of a SMS short message, or else in a channel transmitting data according to the WAP wireless application protocol.

The request is forwarded to the central manager server 30 by the station 20, through the local server 10. The processor 31, which receives it, then consults the table 32 so as here to determine, firstly, whether at least one other receiver appliance 1 to 4 of the network has already formulated a similar request, in respect of the same programme, and is still active. If not, this indicates that it has not assigned the sender appliance 9 a group of broadcasting paths in respect of this programme and that it does not therefore send it into the network. The processor 31 then instructs the network 40 to allocate such a group of send paths to the sender appliance 9, if the rights of the appliance 1 which are stored in the table 32 make it possible to satisfy its request. As mentioned hereinabove, the part of the table 32 which is a centralized copy of the various local tables 12, indicating in detail the programmes broadcast and the receiver appliances 1 to 4 which receive them, is optional and serves here merely to avoid the time loss which would be constituted by a consultation of each local server 10 by the central server 30 with each request from an appliance 1 to 4.

The send/receive circuits 92 store the numbers or indices of the temporal paths in the frame forming each group of paths, in association with the identifier of the corresponding programme of the table 91. The sources, not represented, of these programmes (video tape reader, external network for supplying video and other data) are then linked to the paths of the group by the circuits 92.

Subsequently, the table 32 indicates to the processor 31 whether the group of send paths culminates in particular at the station 20 of the requester 1, that is to say whether some other appliance 2 to 4 is already receiving the relevant programme in the cell of the station 20. As a variant, the central server 30 is merely a simple table of the rights of the appliances 1 to 4 and it is then the microprocessors 11 of the various local servers 10 which talk to one another in order to ascertain the general state of the programme broadcasts and to update the tables 12.

In the negative, the station 20 not already receiving this group of paths, it is registered, for a first time, in the tables 32 and 12 opposite the relevant programme, just like here the appliance 1. The processor 31 then instructs the station 20 and the processor 11 to allocate a group of paths of appropriate size to the requester appliance 1. The processor 11 furthermore instructs the transmission network 40 to link the sender station 9 to the local server 10 and hence to the receiver station 20. The processor 11 registers, in the table 12, the index numbers of the group paths allocated to the appliance 1 in the frame of its cell. To this end the processor 11 fills in the table 21, which indicates, for each temporal path of the frame of each cell, the identity of the appliance 1 to 4 to which the path has been allocated. To this end the relevant appliance 1 receives, via the hereinabove signalling channel, the copy of the part of the table 21 which relates to it, so as to select and process the group of temporal reception paths which have been allocated to it.

In the affirmative, the group of broadcasting paths therefore already culminated at the station 20. The station 20 is then registered likewise, by the processor 11, for a second time or more in the table 12 with the appliance 1. However, the group of reception paths which is allocated to the appliance 1 in the table 21, under instruction from the processor 11, is then the same as that already allocated to another appliance 2 to 4 in respect of the relevant programme in the cell of the station 20. This group of common paths therefore constitutes a broadcasting bus to which any appliance 1 to 4 can link.

The other temporal paths of the relevant frame therefore remain available for the conventional telephonic traffic or possibly traffic of other programmes.

As a variant, and in a general manner, whether the network be cellular as here or non-cellular, a first appliance 1 being already linked to the sender appliance 9 following a request relating to a specified programme, a second appliance 2, formulating a similar request, hence in respect of the same programme, the network links it to the group of broadcasting paths which was previously allocated to the first appliance 1.

In this example, the network here being cellular and receiving a current request from an appliance 1 of a cell of a station 20, it determines whether a high bit rate transmission has already been established in the cell so as, in the affirmative, to regard the appliance 1 formulating the current request as being a second receiver appliance 2 to 4, which will therefore be processed as indicated immediately hereinabove.

As a variable, the appliances 1 to 4 are not registered in the table 12, (32) and the processor 11, (31) counts, for each station 20, 25 and each programme, the number of reception requests and the number of corresponding disconnections (as explained hereinbelow). For a station 20, a programme then remains registered, a single time, in the table 12, (32), so long as the number of reception requests is strictly greater than the number of corresponding disconnections.

To update the table 12, (32), by erasing the receiver appliances 1 to 4 which become inactive again, the processor 11, (31) monitors, in each cell like that of the station 20, the receiver appliances 1 to 4 linked to the sender appliance 9 and it instructs, via the tables 21, 26, the interruption of the transmission of the data in the relevant cell when a last receiver appliance 1 to 4 becomes inactive. The relevant data stream originating from the sender appliance 9 is then no longer transmitted to the relevant station 20.

The appliances 1 to 4 here confirm cyclically, via the service channel, their requests for linking with the sender appliance 9, so as to avoid automatic disconnection by the GSM network. To this end the processor 11 comprises a watchdog device processing each receiver appliance 1 to 4 of the table 12, which erases it therefrom in the absence of receipt of confirmation of connection request for a duration exceeding a maximum threshold. As a variant, the appliances 1 to 4 send disconnection requests explicitly.

To manage the mobility of the receiver appliances 1 to 4 and to avoid any cutting of the reception of a programme when an active appliance 2 to 4 enters a new cell, the processor 11, (31) informed of this event by the base station 25 of the new cell, regards this entry as a request for connection to the sender appliance 9, in respect of the relevant programme, relating to the new cell. The user of the relevant appliance 1 to 4 is therefore not required to send a new request and does not notice the change of cell.

It is appreciated that the invention applies also to digital networks other than the GSM network of this example. Likewise, the sender appliance 9 can be linked to the network by high bit rate wire or radio links and for example be a server of a computer network of the Internet kind operating as a sender of a continuous stream of data (streaming) which can be picked up by the receivers at any moment.

As sender, it is also possible to imagine videophone or teleconferencing terminals (higher quality picture and/or sound), each sending to several others in a group of common paths according to the invention.

1. Method of high bit rate data transmission between a sender appliance (9) and receiver appliances (1, 2, 3, 4) of a digital radiotelephony network, in which, at the request of receiver appliances of a plurality of these appliances (1, 2, 3, 4), the data are transmitted to these receiver appliances through a group of common broadcasting paths, method characterized in that each receiver appliance (1, 2, 3, 4) processes the data only regarding its own request, the receiver appliances (1, 2, 3, 4) cyclically confirming their requests so as to avoid automatic disconnection by the network.

2. Method according to claim 1, in which,
a first receiver appliance (1) transmits a request for connection with the sender appliance (9) to the network,
the network, receiving the request, supplies the group of transmission paths to the sender appliance (9), and it links the first receiver appliance (1) thereto and
a second receiver appliance (2) formulating a similar request, the network links it to the said group of broadcasting paths.

3. Method according to claim 2, in which, the telephone network being cellular and receiving a current request from a receiver appliance (2) of a cell, it determines whether a high bit rate transmission has already been established in the said cell so as, in the affirmative, to regard the appliance (2) formulating the current request as being a second receiver appliance.

4. Method according to claim 3, in which the network monitors, in each cell, the receivers (1, 2, 3, 4) linked to the sender appliance (9) and it interrupts the transmission of the data in the relevant cell when a last receiver appliance becomes inactive.

5. Method according to claim 3, in which the network detects the entry of a receiver (1, 2, 3, 4) into a new cell and regards this entry as a request relating to the new cell.

6. Method according to claim 1, in which the receivers (1, 2, 3, 4) transmit their requests via a service channel.

7. System for high bit rate data transmission comprising a digital radiotelephony network (10, 20, 25, 30, 40), with data transmission paths and a manager (10, 30) for allocating the paths, system characterized in that the manager (10, 30) comprises means (11) for updating a table (12, 32) of transmission requests from various receiver appliances (1, 2, 3, 4) and for, at their request, allocating them one and the same group of common data broadcasting paths.
